(19) United States
(12) Patent Application Publication
(10) Pub. No.: US 2008/0134081 A1
(43) Pub. Date: Jun. 5, 2008

(54) INFORMATION LIST DISPLAY METHOD FOR MOBILE TERMINAL

(75) Inventors: Jin Young JEON, Seoul (KR); Nho Kyung HONG, Seoul (KR); Min Hwa JUNG, Seoul (KR); Min Kyung LEE, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/945,086

(22) Filed: Nov. 26, 2007

(30) Foreign Application Priority Data
Dec. 4, 2006 (KR) 2006-0121661

(51) Int. Cl. G06F 3/048; G06F 3/033

(52) U.S. Cl. 715/788; 715/856

(57) ABSTRACT

An information list display method for a mobile terminal is disclosed. The information list display method includes registering an attribute option for information items stored in the mobile terminal; grouping the information items according to registered attribute options; displaying, in response to a list display request, an information list of the grouped information items; and increasing, in response to a zoom-out request, the number of displayed attributes in the information list, and decreasing, in response to a zoom-in request, the number of displayed attributes in the information list. The screen font size is decreased and increased accordingly. As a result, a user, in particular a weak-sighted user, can easily find and view a desired information item, thereby facilitating utilization of the mobile terminal.

### PRIORITY

This application claims priority under 35 U.S.C. §119(a) to a Korean Patent Application entitled “INFORMATION LIST DISPLAY METHOD FOR MOBILE TERMINAL” filed in the Korean Intellectual Property Office on Dec. 4, 2006 and assigned Serial No. 2006-0121661, the contents of which are incorporated herein by reference.

### BACKGROUND OF THE INVENTION

1. Field of the Invention

The present invention relates generally to a mobile terminal and, more particularly, to an information list display method for a mobile terminal that enables display of a list of grouped information items.

2. Description of the Related Art

Advances in information and communication technologies have enabled popularization of mobile terminals. In addition to call processing, an advanced mobile terminal supports various supplementary functions such as message and data transmission and stores a large amount of user information such as photographs, call histories, text messages, and memos.

A mobile terminal provides an information list to enable a user to easily find a desired information item among a large number of stored information items. In response to a user request for information list display, the mobile terminal sorts stored information items, according to a preset option, and displays an information list of sorted information items. The information list normally includes titles of the sorted information items.

However, the user may have difficulty in recalling contents of an information item from a displayed title. Hence, to find a desired information item, the user may be inconvenienced by having to select and check multiple information items through multiple keystrokes. In addition, as a mobile terminal has a relatively small screen of a preset font size, a weak-sighted user may have difficulty in viewing displayed titles of information items.

### SUMMARY OF THE INVENTION

The present invention has been made in view of the above problems, and the present invention provides an information list display method for a mobile terminal that enables the user to easily find a desired information item.

The present invention also provides an information list display method for a mobile terminal wherein stored information items are grouped according to selected attributes and a list of grouped information items is displayed on demand.

The present invention further provides an information list display method for a mobile terminal wherein a list of titles and grouping attributes can be displayed together.

The present invention further provides an information list display method for a mobile terminal wherein the screen font size can be increased and decreased if necessary.

In accordance with an exemplary embodiment of the present invention, there is provided an information list display method for a mobile terminal that includes registering an attribute option for information items stored in the mobile terminal; grouping the information items according to registered attribute options; displaying, in response to a list display request, an information list of the grouped information items; and increasing, in response to a zoom-out request, a number of displayed attributes in the information list, and decreasing, in response to a zoom-in request, the number of displayed attributes in the information list.

### BRIEF DESCRIPTION OF THE DRAWINGS

The above and other objects, features, and advantages of the present invention will be more apparent from the following detailed description in conjunction with the accompanying drawings, in which:

FIG. 1 illustrates a configuration of a mobile terminal according to an exemplary embodiment of the present invention;

FIG. 2 is a flow chart illustrating an information list display method according to another exemplary embodiment of the present invention;

FIG. 3 is a flow chart illustrating a list editing procedure in the method of FIG. 2;

FIGS. 4A and 4B are screen representations illustrating the procedure of FIG. 3;

FIG. 5 is a flow chart illustrating an information grouping procedure in the method of FIG. 2;

FIG. 6 is a flow chart illustrating a list display procedure in the method of FIG. 2;

FIGS. 7A, 7B, 7C, and 7D are screen representations illustrating zoom-out and zoom-in operations; and

FIGS. 8A, 8B, 8C, 8D, 9A, 9B, 9C, and 9D are screen representations illustrating cursor movement on a screen.

### DETAILED DESCRIPTION OF EXEMPLARY EMBODIMENTS

Hereinafter, exemplary embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail.

In the description, the term “information item” refers to a unit of information that can be identified, selected, stored, and retrieved by the user. An information item may be a text message, a MPEG-1 Audio Layer 3 (MP3) audio file, a photograph, a call history of telephone numbers, or a memo. The term “attribute” refers to a descriptive property of an information item. An information item may have a plurality of attributes. Information items of the same type may have identical attributes. The term “attribute option” refers to an attribute that is registered in a mobile terminal and is usable for grouping information items. A plurality of attributes can be registered as attribute options. Table 1 illustrates various attribute options according to types of information items.

TABLE 1

| Information Item | Attribute Option |
|---|---|
| text message | date, time, sender, recipient, importance, |
| | size |
| MP3 file | date, time, artist, size, title |
| photograph | date, time, size, title |
| telephone number | date, time, group, name |
| call list | date, time, counterpart |
| memo | date, time, size, title |

Attribute options can be organized in a multi-level hierarchy, and information items can be grouped in a stepwise manner on the basis of levels of selected attribute options.

The term “attribute list” refers to a list of attribute values of an attribute option selected as a criterion for grouping information items. For example, when received messages are grouped by an attribute option “sender,” the list of message senders is an attribute list. Hence, a single attribute list can be created for a registered attribute option, and attribute lists can also be organized in a multi-level hierarchy comparable to that of corresponding attribute options. The term “title list” refers to a list of identifiers of information items in a group. The identifier of an information item may be a title of the information item or a portion of the information item itself. The term “information list” refers to a title list or to a title list and at least one attribute list.

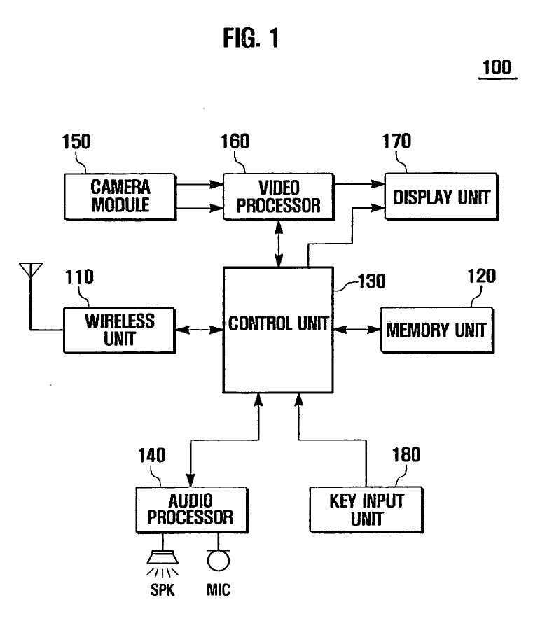

FIG. 1 illustrates a configuration of a mobile terminal 100 according to an exemplary embodiment of the present invention. For the purpose of the following description, the mobile terminal 100 is assumed to be a mobile phone.

Referring to FIG. 1, the mobile terminal 100 includes a wireless unit 110, a memory unit 120, a control unit 130, an audio processor 140, a camera module 150, a video processor 160, a display unit 170, and a key input unit 180.

The wireless unit 110 performs wireless communication operations for the mobile terminal 100. The wireless unit 110 includes a Radio Frequency (RF) transmitter for upconverting the frequency of a signal to be transmitted and amplifying the signal, and an RF receiver for low-noise amplifying a received signal and downconverting the frequency of the received signal.

The memory unit 120 includes a program memory section and a data memory section. The program memory section stores executable programs of the mobile terminal 100. In particular, the program memory section stores a program for registering an attribute option, grouping stored information items on the basis of a selected attribute option, and displaying an information list of grouped information items. The data memory section stores data resulting from execution of the programs and information items created during operation of the mobile terminal 100.

The control unit 130 controls the overall operation of the mobile terminal 100. The control unit 130 performs a signal processing function to encode and modulate a signal to be transmitted, and to demodulate and decode a received signal. The control unit 130 may include a MOdulator/DEModulator (MODEM) and a COder/DECoder (CODEC).

In particular, the control unit 130 controls display of an information list using registered attribute options. That is, the control unit 130 controls a display operation to increase a number of displayed attribute lists in the information list in response to a zoom-out request from the user, and to reduce the number of displayed attribute lists in response to a zoom-in request. Thereto, the control unit 130 registers attribute options selected by the user, and groups, in advance, information items stored in the memory unit 120 on the basis of the registered attribute options.

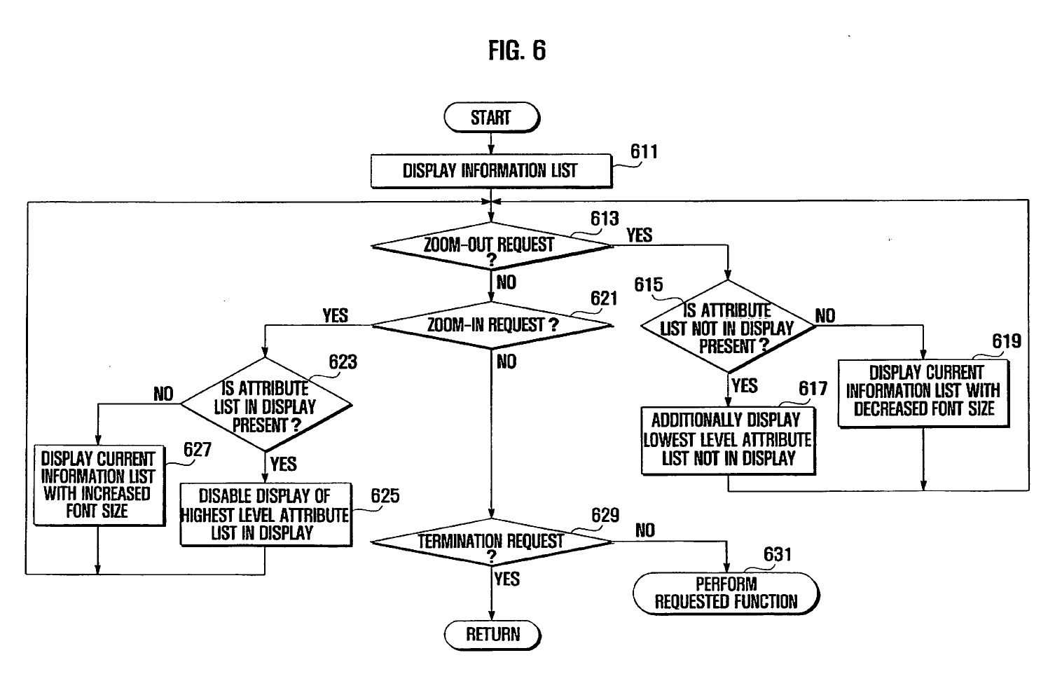

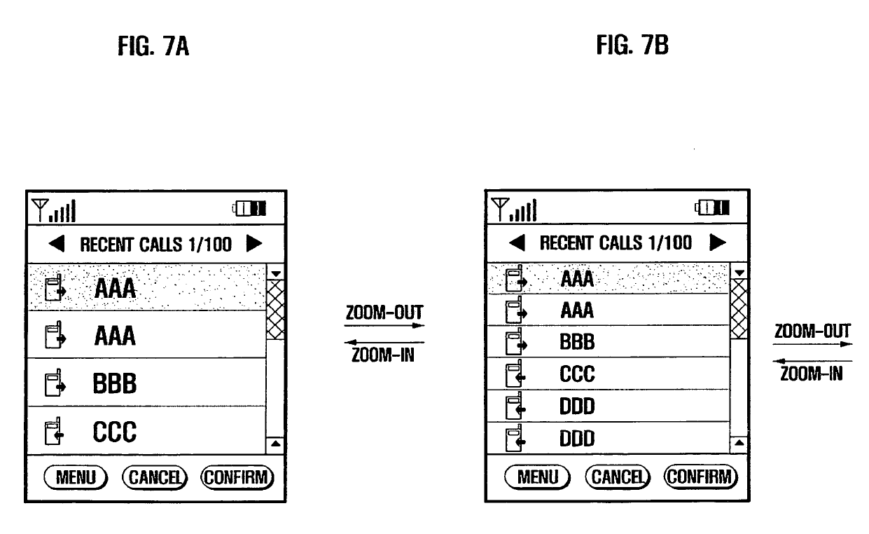

In response to a zoom-out request, the control unit 130 checks whether an undisplayed attribute list is present. If an undisplayed attribute list is present, the control unit 130 controls a display operation to display a lowest-level undisplayed attribute list in addition to a currently displayed information list (namely, the number of displayed attribute lists is increased) using a decreased screen font size, as illustrated by the transition from FIG. 7B to FIG. 7C. If an undisplayed attribute list is absent, the control unit 130 controls the display operation to display the current information list using a decreased screen font size, as illustrated by the transition from FIG. 7A to FIG. 7B.

In response to a zoom-in request, the control unit 130 checks whether a displayed attribute list is present. If a displayed attribute list is present, the control unit 130 disables display of the highest-level displayed attribute list and displays the information list without the disabled attribute list (namely, the number of displayed attribute lists is decreased) using an increased screen font size, as illustrated by the transition from FIG. 7C to FIG. 7B. If a displayed attribute list is not present, the control unit 130 displays the current title list using an increased screen font size, as illustrated by the transition from FIG. 7B to FIG. 7A.

The audio processor 140 reproduces an audio signal from an audio codec of the control unit 130 through a speaker SPK, and transmits an audio signal from a microphone MIC to the audio codec.

The camera module 150 generates images of target objects. The camera module 150 includes a lens for forming an image of a target object, an image sensor for converting an optical signal corresponding to the formed image into an electrical signal, and an image signal processor for converting the analog electrical signal from the image sensor into digital data. The image sensor may be a Charge-Coupled Device (CCD) sensor, and the image signal processor may be a Digital Signal Processor (DSP). The image sensor and image signal processor may be realized as separate bodies or as a single body.

The video processor 160 generates screen data to display an image signal from the camera module 150. The video processor 160 processes the image signal in frame units and outputs frame image data corresponding to display characteristics and the size of the display unit 170. The video processor 160 includes a video codec to compress frame image data to be displayed through the display unit 156 in a preset format, and to decompress compressed frame image data. The video codec may be a Joint Photographic Experts Group (JPEG) codec, Moving Picture Experts Group (MPEG) codec, or a Wavelet codec.

The display unit 170 displays image data from the video processor 160, and data from the control unit 130 on a screen. The display unit 170 may include a panel of Liquid Crystal Display (LCD) devices, a LCD controller, and a memory device for storing image data to be displayed. If the panel has a touch screen capability, the display unit 170 can also act as an input means.

The key input unit 180 includes a plurality of keys for inputting alphanumeric data, and a plurality of function keys for setting various functions. The key input unit 180 may further include keys for zoom-in and zoom-out requests.

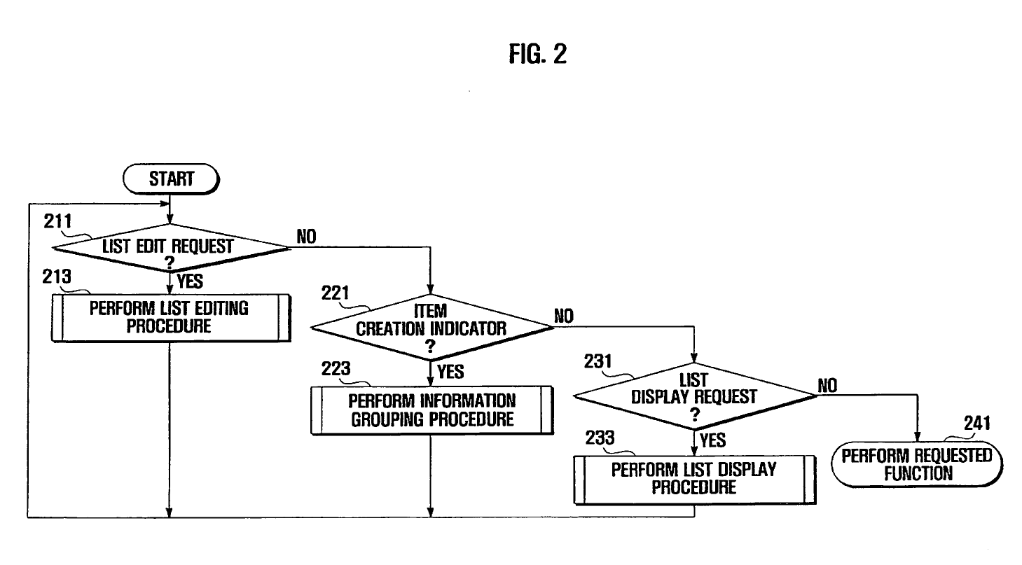

FIG. 2 is a flow chart illustrating an information list display method according to another exemplary embodiment of the present invention.

Referring to FIGS. 1 and 2, when an input event is detected, the control unit 130 of the mobile terminal 100 determines whether the input event is a list edit request issued by the user, in Step 211. If a list edit request is issued, the control unit 130 performs a list editing procedure permitting the user to select and register an attribute option for grouping information items stored in the memory unit 120, in Step 213.

If the input event is not a list edit request, the control unit 130 determines whether the input event is an information item creation indicator, in Step 221. An information item can be created, for example, when the user inputs some information through the key input unit 180 or when external media content is received through the wireless unit 110. If an information item is created, the control unit 130 performs an information grouping procedure to regroup existing information items and the newly created information item according to attribute options registered in advance, in Step 223.

If the input event is not an information item creation indicator, the control unit 130 determines whether the input event is a list display request issued by the user, in Step 231. If a list display request is issued, the control unit 130 performs a list display procedure, in Step 233. That is, the control unit 130 controls a display operation, to display a grouped information items information list, to decrease the number of displayed attribute lists with an enlarged screen font in response to a zoom-in request, and to increase the number of displayed attribute lists with a reduced screen font in response to a zoom-out request.

If the input event is a request for another function, the control unit 130 performs the requested function, in Step 241.

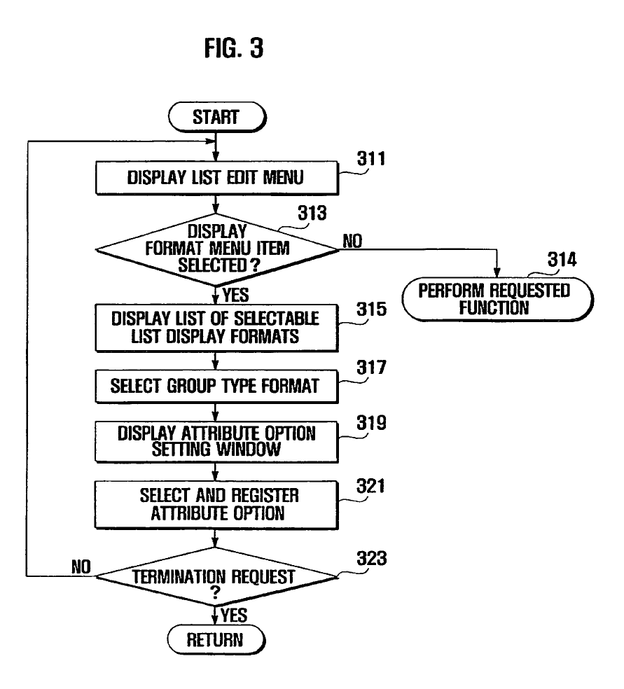

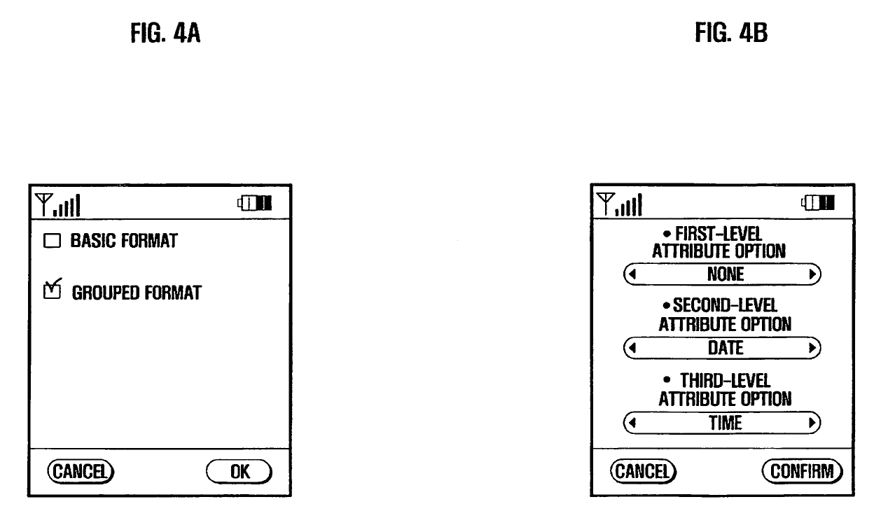

FIG. 3 is a flow chart illustrating a list editing procedure in the method of FIG. 2. FIG. 4A is a screen representation for selection of a display format for information list display, and FIG. 4B is a screen representation for registration of multi-level attribute options.

Referring to FIGS. 1, 3, 4A, and 4B, in response to a list-edit request, the control unit 130 displays a list-edit menu, in Step 311. If the user selects a display format menu item in the list-edit menu, in Step 313, the control unit 130 displays a list of selectable list display formats, as illustrated in FIG. 4A, in Step 315. If the user selects a menu item other than the display format menu item, the control unit 130 performs a function associated with the selected menu item, in Step 314.

When the user selects a group type format in a display format list, in Step 317, the control unit 130 displays an attribute option-setting window for selecting a desired attribute option, as illustrated in FIG. 4B, in Step 319. The attribute option-setting window may include multiple input boxes for selecting multi-level attribute options.

When the user selects at least one attribute option in the attribute option setting window, the control unit 130 registers the selected attribute options, in Step 321. FIG. 4B illustrates selection of two attributes “date” and “time” as a second-level attribute option and a third-level attribute option, respectively. Because a first-level attribute option is not selected, the attribute option “date” is the highest attribute option and the attribute option “time” is the lowest attribute option.

Thereafter, if the user issues a termination request, in Step 323, the control unit 130 terminates the list editing procedure and returns. Otherwise, the control unit 130 returns to step 311 for further attribute option processing.

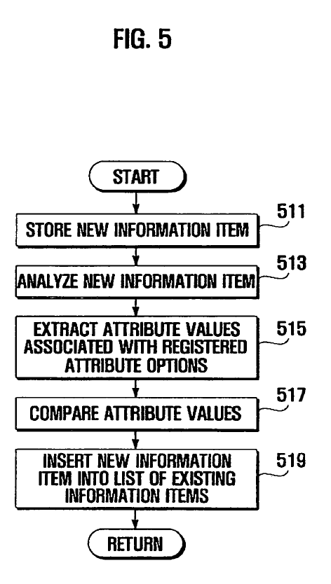

FIG. 5 is a flow chart illustrating an information grouping procedure performed in the method of FIG. 2.

Referring to FIGS. 1 and 5, in response to creation of an information item, the control unit 130 stores the newly created information item in the memory unit 120, in Step 511. Existing information items are stored in the memory unit 120, and are sorted into groups on a basis of multi-level attribute options registered in advance. The control unit 130 analyzes the newly created information item, in Step 513, and extracts values of attributes corresponding to the registered attribute options from the newly created information item, in Step 515. The control unit 130 compares the extracted attribute values of the newly created information item with corresponding attribute values of existing information items, in Step 517. At Step 517, the comparison is performed for each registered attribute option in order of levels. Finally, the control unit 130 creates a new information list of grouped information items by merging the newly created information item and the list of existing information items using the comparison results, in Step 519, and returns.

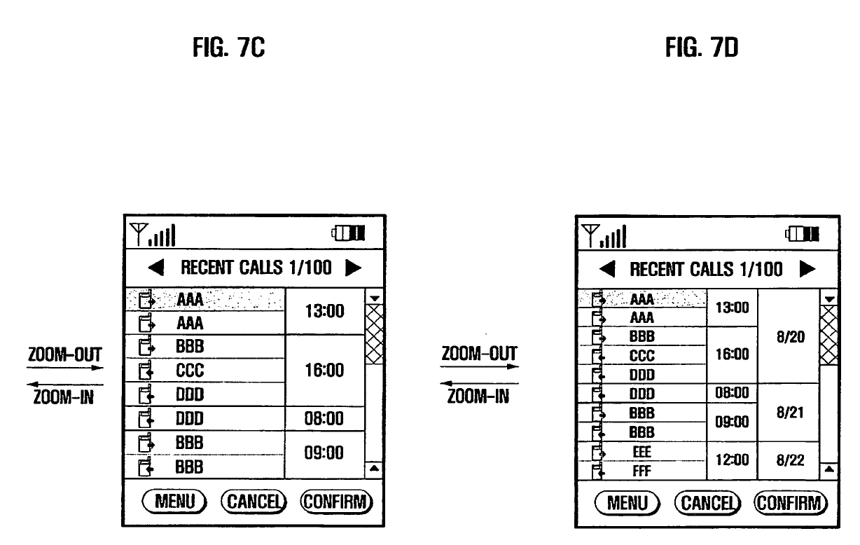

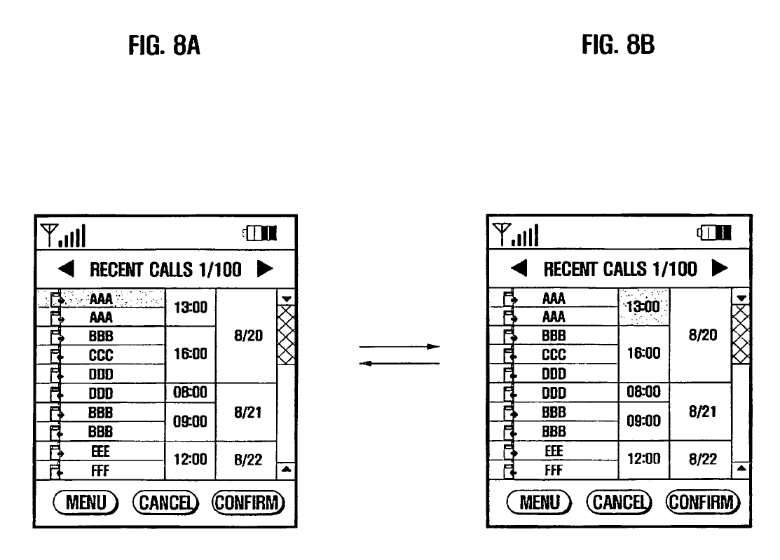

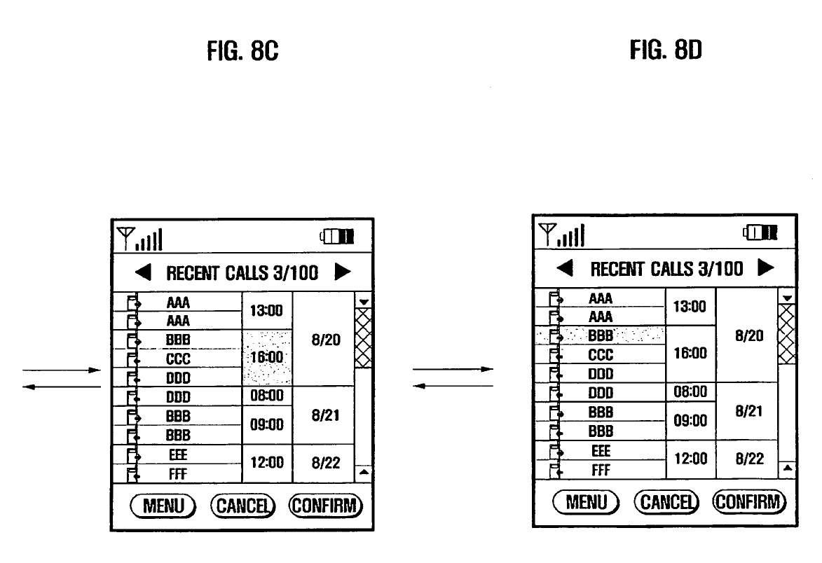

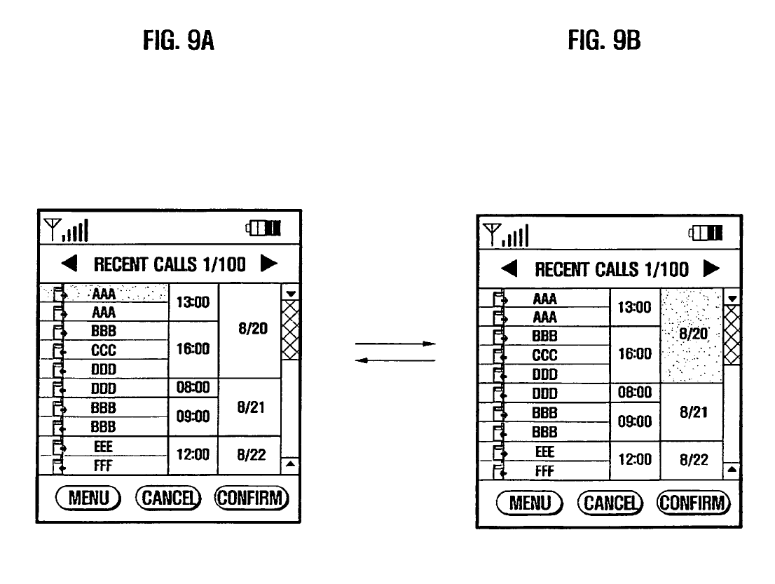

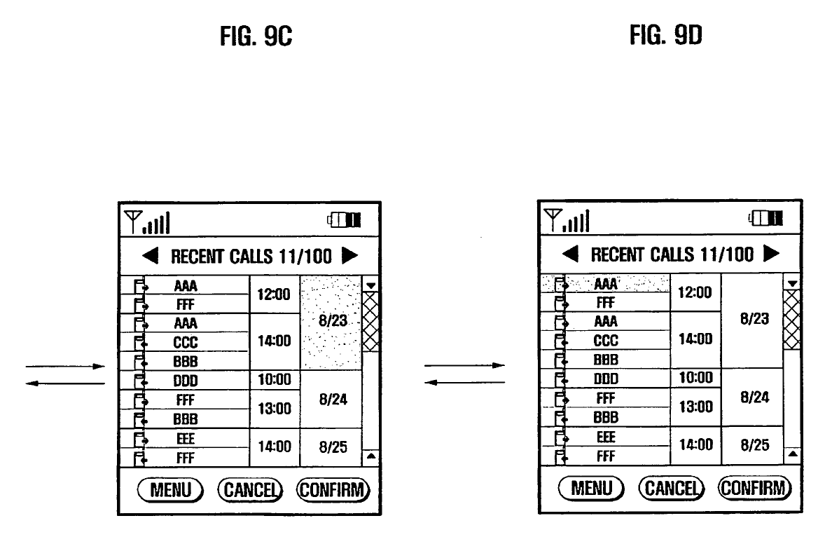

FIG. 6 is a flow chart illustrating a list display procedure in the method of FIG. 2. FIGS. 7A through 9D are screen representations for information list display according to the procedure of FIG. 6. FIGS. 7A through 7D illustrate increment and decrement of the number of displayed attribute lists in response to a zoom-out request and zoom-in request. FIGS. 8A through 9D illustrate various cursor moves on the screen in response to input of preset keys.

In FIGS. 7A through 9D, a call history is described as an example, a title list is a counterpart list, a lowest-level attribute list is a time value list, and a highest-level attribute list is a date value list. Counterpart identifiers are sorted by date values into date groups of counterpart identifiers associated with the same date value. Those counterpart identifiers in each date group are further sorted by time values into time groups of counterpart identifiers associated with the same time value. Each group is represented by a single attribute value during display (identical attribute values are merged into one).

Referring to FIGS. 1, and 6 through 9D, in response to a list display request, the control unit 130 displays an information list through the display unit 170, in Step 611. As illustrated in FIGS. 7A through 7D, the information list includes a single title list, or a title list and at least one attribute list. In response to an input event from the user, the control unit 130 determines whether the input event is a zoom-out request, in Step 613. If the input event is a zoom-out request, the control unit 130 checks whether an undisplayed attribute list is present, in Step 615.

If an undisplayed attribute list is present, the control unit 130 displays the lowest-level undisplayed attribute list in addition to the current information list using a decreased screen font size, in Step 617. For example, when a zoom-out request is issued by the user, in a state where the counterpart list is displayed as illustrated by FIG. 7B, the time value list is additionally displayed as illustrated by FIG. 7C. When a zoom-out request is issued by the user in a state where the counterpart list and the time value list are displayed as illustrated by FIG. 7C, the date value list is additionally displayed as illustrated by FIG. 7D.

If an undisplayed attribute list is absent, the control unit 130 displays the current information list using a decreased screen font size, in Step 619. For example, in a case when a zoom-out request is issued by the user in a state where the counterpart list, time value list, and date value list are displayed as illustrated by FIG. 7D, as no undisplayed attribute list is present, the current information list, including the counterpart list, time value list and date value list, is continuously displayed using a decreased screen font size. Decrement of the screen font size permits additional items of the information list to be displayed on the screen.

If the input event is not a zoom-out request, the control unit 130 determines whether the input event is a zoom-in request, in Step 621. If the input event is a zoom-in request, the control unit 130 checks whether a displayed attribute list is present, in Step 623. If a displayed attribute list is present, the control unit 130 disables display of the highest-level displayed attribute list and displays the information list without the disabled attribute list using an increased screen font size, in Step 625. For example, when a zoom-in request is issued by the user, in a state where the counterpart list, time value list, and date value list are displayed as illustrated by FIG. 7D, the control unit 130 disables display of the date value list and displays the counterpart list and time value list as illustrated by FIG. 7C. When a zoom-in request is issued by the user in a state where the counterpart list and time value list are displayed as illustrated by FIG. 7C, the control unit 130 disables display of the time value list and displays the counterpart list as illustrated by FIG. 7B.

If a displayed attribute list is not present, the control unit 130 displays the current title list using an increased screen font size, in Step 627. For example, in the case when a zoom-in request is issued by the user in a state where the counterpart list is displayed as illustrated by FIG. 7B, as no displayed attribute list is present, the counterpart list is continuously displayed using an increased screen font size as illustrated by FIG. 7B. Increment of the screen font size permits easier viewing of the information list (title list) displayed on the screen.

If the input event is a request for a function other than zooming-out and zooming-in, the control unit 130 performs the requested function, in Step 631. For example, if the input event is a cursor movement request associated with a preset key of the key input unit 180. Cursor movement, performed through button presses in various directions for various time intervals, in a state where an information list is displayed is described in connection with FIGS. 8 and 9.

Step 613 and subsequent steps may be repeated until the user issues a termination request, in Step 629. That is, the control unit 130 can perform zoom-out and zoom-in operations in sequence according to user requests.

FIGS. 8A through 8D illustrate cursor movement between the counterpart list and time value list in response to input of preset keys.

In response to input of a right direction request when the cursor is placed on a first counterpart identifier as illustrated by FIG. 8A, the control unit 130 moves the cursor to a time value field associated with the first counterpart identifier as illustrated by FIG. 8B. In response to input of a down direction request in a state illustrated by FIG. 8B, the control unit 130 moves the cursor to a next time value field as illustrated by FIG. 8C. In response to input of an up direction request in a state illustrated by FIG. 8C, the control unit 130 moves the cursor to a preceding time value field as illustrated by FIG. 8B. In response to input of a left direction request in a state illustrated by FIG. 8C, the control unit 130 moves the cursor to the first counterpart identifier associated with the current time value field as illustrated by FIG. 8D.

FIGS. 9A through 9D illustrate cursor movement between the counterpart list and the date value list in response to input of preset keys.

In response to input of a right direction request when the cursor is placed on a first counterpart identifier as illustrated by FIG. 9A, the control unit 130 moves the cursor to a date value field associated with the first counterpart identifier as illustrated by FIG. 9B. In response to input of a page down request in a state illustrated by FIG. 9B, the control unit 130 moves the cursor to a date value field of the next page as illustrated by FIG. 9C. In response to input of a page up request in a state illustrated by FIG. 9C, the control unit 130 moves the cursor to a date value field of the preceding page as illustrated by FIG. 9B. In response to input of a left direction request in a state illustrated by FIG. 9C, the control unit 130 moves the cursor to the first counterpart identifier associated with the current date value field as illustrated by FIG. 9D.

As apparent from the above description, the present invention provides an information list display method for a mobile terminal. Stored information items are grouped according to selected attributes, and a list of titles and grouping attributes are displayed together on demand. The number of displayed attribute lists is increased and decreased according to zoom-out and zoom-in requests. The screen font size is decreased and increased accordingly. As a result, a desired information item can be easily found, thereby facilitating utilization of the mobile terminal for the user, in particular a weak-sighted user.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. An information list display method for a mobile terminal, comprising:
registering an attribute option for information items stored in the mobile terminal;
grouping the information items according to registered attribute options;
displaying, in response to a list display request, an information list of the grouped information items; and
increasing, in response to a zoom-out request, a number of displayed attributes in the information list, and decreasing, in response to a zoom-in request, the number of displayed attributes in the information list.

2. The information list display method of claim 1, wherein the grouping the information items comprises:
extracting attribute values corresponding to the registered attribute options from each information item; and
comparing the extracted attribute values, for each registered attribute option, with each other to merge identical attribute values into one value.

3. The information list display method of claim 2, wherein the registered attribute options include multi-level attribute options, and wherein in the grouping the information items, the registered attribute options are used one at a time from a highest-level attribute option to a lowest-level attribute option for grouping the information items.

4. The information list display method of claim 3, wherein the information list comprises a title list, or a title list and at least one attribute list.

5. The information list display method of claim 4, wherein the displaying an information list comprises:
checking, in response to a zoom-out request, whether an undisplayed attribute list is present;
displaying, if an undisplayed attribute list is present, a lowest-level undisplayed attribute list in addition to a current information list; and
displaying, if an undisplayed attribute list is absent, the current information list.

6. The information list display method of claim 5, wherein the displaying the information list further comprises reducing a screen font size in response to the zoom-out request.

7. The information list display method of claim 4, wherein the displaying an information list comprises:
checking, in response to a zoom-in request, whether a displayed attribute list is present;
disabling, if a displayed attribute list is present, display of the highest-level displayed attribute list and displaying the information list without a disabled attribute list; and
displaying, if a displayed attribute list is absent, a current information list.

8. The information list display method of claim 7, wherein the displaying the information list further comprises increasing a screen font size in response to the zoom-in request.

9. The information list display method of claim 4, wherein the displaying the information list comprises:
checking, in response to a user request when a cursor is placed on a displayed information list, whether a displayed attribute list is present;
moving, if a displayed attribute list is present, the cursor to the highest-level displayed attribute list; and
placing, if a displayed attribute list is not present, the cursor on the information list without movement.

10. The information list display method of claim 4, wherein the displaying an information list comprises:
checking, in response to a user request when a cursor is placed on a displayed information list, whether the cursor is on the title list;
placing, if the cursor is on the title list, the cursor on the title list without movement; and
moving, if the cursor is not on the title list, the cursor to the title list.

11. The information list display method of claim 4, wherein the displaying the information list comprises:
checking, in response to a user request when the information list is displayed, whether the title list has an undisplayed item;
displaying, if the title list has an undisplayed item, items of an undisplayed title list; and
maintaining, if the title list has no undisplayed items, a current display state without action.
